(19) United States
(12) Patent Application Publication
(10) Pub. No.: US 2016/0243431 A1
(43) Pub. Date: Aug. 25, 2016

(54) CONNECTION GAME

(71) Applicant: Gary Peterson, Chicago, IL (US)

(72) Inventor: Gary Peterson, Chicago, IL (US)

(21) Appl. No.: 15/052,468

(22) Filed: Feb. 24, 2016

Related U.S. Application Data
(60) Provisional application No. 62/120,857, filed on Feb. 25, 2015.

(51) Int. Cl. A63F 3/00; A63F 13/25

(52) U.S. Cl. CPC A63F 3/00094; A63F 3/00214; A63F 3/00643; A63F 13/25

(57) ABSTRACT

A game includes a playing area including a grid arrangement of nine playing positions, each playing position including three concentric playing locations within the playing position, each playing location having an associated cylindrical receiving shape; and four sets of game pieces, each set of game pieces including three subsets of game pieces, each subset of game pieces including game pieces having a form corresponding to one of the playing location receiving shapes, including a solid cylinder having a first diameter, a hollow cylinder having a second diameter larger than the first diameter, and a hollow cylinder having a third diameter larger than the second diameter.

### BACKGROUND OF THE INVENTION

The present subject matter relates generally to a connection game. More specifically, the present invention relates to a scalable, multi-player, multi-dimensional connection game in which each player attempts to connect related game pieces in specific patterns in playing positions on a game board, wherein each playing position accommodates multiple types of game pieces, whether from a single player or multiple players.

Connection games (sometimes called “games of alignment”) are played in virtually every society in the modern world. Most commonly these games involve two players attempting to obtain a three-in-a-row (e.g., Tic-Tac-Toe) or four-in-a-row (e.g., Connect Four) alignment of a single player's marker (e.g., colored tile, alphanumeric character, symbol, or other game piece) on a square game grid for a player to achieve victory. Of these games, likely the most universal is Tic-Tac-Toe. Dating back to the Roman Empire, the game involves two players, each of whom get a designated marker (typically the letter X or O). The two players, designated by X and O, then take turns marking spaces on a three by three square grid with their markers eliminating the marked spaces from use by the other player. Once a marker is placed on the grid, it cannot be moved and the player who succeeds in placing three of their marks in a horizontal, vertical, or diagonal row wins the game.

A single game of Tic-Tac-Toe typically lasts less than one minute and due to its simplistic rules, is known as a solved game. This means it is possible to deduce the outcome of each Tic-Tac-Toe game based off the first move played assuming both players play perfectly. The outcome of a perfectly played Tic-Tac-Toe game is famously a draw and while playing perfectly may sound difficult, given the basic nature of the game, creating a computer program which plays tic-tac-toe perfectly is common assignment given to programing students. Tic-tac-toe has 255,168 different sequences of moves possibly playable for the duration of a game and while this may sound like a larger number, it is actually indicative of the games' simple nature as, by comparison, a more complex games like Chess has more sequences of moves possibly playable during a game than there are number of atoms in the observable universe (over 10¹²⁰).

Since Tic-Tac-Toe is basic in nature, it is easy to learn and play anywhere, but given its comparatively limited number of possible outcomes, can become repetitive and less enjoyable to play over time. This diminished replay value has led to many variations on Tic-Tac-Toe with almost all of them seeking to increase the number of possible outcomes. Likely the most famous variation on Tic-Tac-Toe is a game sold by Hasbro, Inc. under the trademark Connect Four. Instead of requiring a three-in-a-row alignment for victory, Connect Four requires a four-in-a-row alignment. The game also features a playing grid which sits perpendicular to the surface the game is being played on, giving the game another level of novelty. The game was first sold under the Connect Four name by game company Milton Bradley in February 1974, but, like Tic-Tac-Toe, the rules of a four-in-a-row connection game date back to pre-Christian antiquity. The original version of Connect Four (released in 1974) is played on a six high by seven wide grid which results in 4,531,985,219,092 possible sequences of moves playable during a given game. While this is an exponentially large increase over the number of playing positions found in Tic-Tac-Toe, Connect Four is also a solved game. As mentioned previously, while Tic-Tac-Toe will end in a draw if perfectly played, Connect Four will instead end in the first player to play winning the game when both sides play a perfect game.

Given that the most popular connection games are solved and that only two players can play them at a time, there is a need for a more complex connection games. There is, however, not an obvious solution to provide such complexity while preserving the casual, approachable, pick-up-and-play appeal of these basic games. Raising the number of markers in a row (e.g., five-in-a-row) required for victory is one possible way to add complexity, but as the number of markers-in-a-row required to win increases, so do the requirements for space (i.e., a larger game grid) and time to play. This may lead players to opt for more complex games (e.g., chess, Settlers of Catan®, Risk®) which offer higher level game play than the mere challenge of aligning markers or, worse yet, to simply not play at all.

Another option for added complexity in connection games is to utilize the current numbers of markers required for victory and their corresponding game grids in a novel way. This too is difficult because given the small scale and simple nature of Tic-Tac-Toe, Connect Four, and other connection games there is little room for change without fundamentally altering the game. One solution could be to allow players to both occupy the same position on the game grid, opening up more possible moves. This solution does not mesh well with current iterations of connection games, however, because not only do the game rules prevent a playing position from being used by more than one player, but the markers used in Tic-Tac-Toe and Connect Four are physically incapable of occupying the same position on a playing grid at the same time. Connect Four is commonly played with round disk markers, with the game grid capable of only holding one marker in each playing position on the grid. Tic-Tac-Toe is most commonly played with the letters X and O acting as the respective player's markers; but again, once one marker is placed in a playing position on the game grid, there is no room for another marker at this position without altering the already placed marker.

Accordingly, there is a need for a scalable connection game which is playable by multiple players simultaneously and capable of accommodating multiple players' markers at each playing position.

### BRIEF SUMMARY OF THE INVENTION

To meet the needs described above and others, the present disclosure provides a scalable, multi-player, multi-dimensional connection game in which each player attempts to connect related game pieces in specific patterns in playing positions on a game board, wherein each playing position accommodates multiple types of game pieces, whether from a single player or from multiple players.

A preferred embodiment of the game includes a game board and concentric game pieces. Specifically, the game pieces are sets of three, colored, concentric, cylindrical game pieces, with each player starting with three sets of game pieces (nine game pieces for each player in total). During play, these game pieces are placed on the game board's playing area, which is a square grid of playing positions laid out in a three by three pattern. These playing positions allow multiple game pieces, controlled by any of the multiple players, to simultaneously occupy distinct playing locations on the same playing position. For example, this simultaneous occupancy of multiple locations within a single playing position may be provided by enabling the concentric game pieces to fit into corresponding concentric grooves in the game board. These grooves, which act as the playing locations, resemble a bull's-eye in shape when viewed from above and, when full, are capable of holding three concentric game pieces with each differently sized piece belonging to a single player or multiple players.

As mentioned above, in a preferred embodiment, the game board may be approximately square in shape and may be made of wood or any other suitable material. The approximate dimensions of the entire board may be fourteen inches wide, fourteen inches long, and three eights of an inch tall. The playing area of the board may be approximately eight inches wide by eight inches long and be cut into the top face of the board. The bottom face of the board may be featureless to allow the board to sit level on a flat surface. The corners of the square game board may also be cutaway, giving the game board a shape similar to a plus sign. The game board may also feature game piece holders, cut to the same dimensions as the playing position grooves, along the perimeter of the board outside the playing area to hold each of a respective player's game pieces when not in use.

In the preferred embodiment, the game pieces may be made of plastic or any other suitable material. The shapes of the pieces in each set may be cylindrical and concentric with each other. This size relation means, when viewed from above, each set of game pieces may resemble a bull's-eye target with a solid center piece and larger, hollow cylindrical pieces radiating outwards with each larger piece surrounding the smaller game pieces in each set. The center game piece may be the smallest in diameter at approximately five-sixteenths of an inch. The next largest game piece (i.e., the medium game piece) may be around one and one-fourth of an inch in diameter, with the largest game piece in each set possibly being around two and one-fourth inches in diameter.

In another embodiment, the number of game pieces in each set may be increased by one over the previous embodiment, giving the player sixteen pieces in total (four of each respective concentrically sized piece). This increase in the number of game pieces used may be compensated for by the addition of more playing positions, forming a four by four square grid with sixteen total playing positions and four playing locations per position.

Still other embodiments of the scalable connection game are contemplated. Some of these embodiments feature a higher ratio of playing positions to game pieces. For example, each player may have three sets of three concentric pieces (nine total pieces per player) while the number of playing positions is increased to sixteen (a four by four grid) or twenty-five (a five by five grid). Any combination of the number of game pieces provided to players, number of playing positions, and number of playing locations available may be utilized in other embodiments to alter the gameplay as desired.

Still other embodiments of the scalable connection game may incorporate multi-dimensional play. These embodiments may utilize multiple playing areas (similar to 3-D Tic-Tac-Toe) oriented on top of one another or a single playing area with the added functionality of game pieces being stackable upon one another.

No matter the embodiment, the gameplay may be characterized as a connection game with goals similar to that of Tic-Tac-Toe or Connect Four. A game begins with one of the players placing any one of their game pieces on the board. Then, following this turn, the player next in turn places one of their game pieces onto the game board. This continues, with each player placing one piece onto the board during their turn, until one player places a winning combination of game pieces onto the board, thus concluding the game. The winning combination, the ultimate goal of the game, may be a predetermined number (e.g., three-in-a-row, four-in-a-row) of the same sized game piece in a horizontal, vertical, or diagonal row. Winning combinations may also consist of one player placing one of all sizes of game piece available (e.g., for a three-piece-per-set game: the small, medium, and large pieces) into one playing position (i.e., one player filling all the playing locations on the respective playing position) or the player placing one of all sizes of game piece available in ascending or descending order of size in a horizontal, vertical, or diagonal row.

For the multi-dimensional embodiments, the winning combinations discussed above may be played out not only on a single plane, but span either multiple playing areas or multiple levels of stacked pieces on the same playing area. As an example, in a three-in-a-row to win game played out on a single playing area, a player may achieve victory by placing three of the same sized game pieces in a row. The alignment of this row can be vertical, horizontal, or diagonal relative to the two-dimensional playing area. When this same winning combination is played out across multiple playing areas, the alignment to win can be not only three of the same sized pieces in a vertical, horizontal, or diagonal row relative to a single two-dimensional playing area, but can also be achieved by placing three of the same size game pieces in a row three-dimensionally across three playing areas. This same three-dimensional effect may be achieved by stacking game pieces on top of one another in a single playing area, allowing players to attempt the same three-dimensional winning alignments discussed above.

Although described above with respect to physical game boards and game pieces, it is understood that the game described herein may be embodied in a video game or other software embodiment. The game board may be displayed on an electronic display and the game play may be controlled by electronic input, whether through a computer, mobile device, gaming console, dedicated electronic device, etc.

In one example, a game includes: a playing area including an arrangement of playing positions, each playing position including two or more playing locations within the playing position, each playing location having an associated receiving shape; and two or more sets of game pieces, each set of game pieces including two or more subsets of game pieces, each subset of game pieces including two or more game pieces having a form corresponding to one of the playing location receiving shapes. For example, the playing locations within each playing position may be concentric. The playing area may be a three by three grid of playing positions, a four by four grid of playing positions, a five by five grid of playing positions, etc. The playing area may be provided on a board (i.e., as a board game) or on a display of an electronic device (i.e., as a software game). The game may be multi-dimensional.

There may be four sets of game pieces and each set of game pieces may include three subsets of game pieces. The three subsets of game pieces may include game pieces in three concentric shapes. The three concentric shapes may include a solid cylinder having a first diameter, a hollow cylinder having a second diameter larger than the first diameter, and a hollow cylinder having a third diameter larger than the second diameter.

The game may further include game piece holding locations that are the same form of the playing locations and are located along the perimeter of the playing area.

In another specific example, a game includes: a playing area including a grid arrangement of nine playing positions, each playing position including three concentric playing locations within the playing position, each playing location having an associated cylindrical receiving shape; and four sets of game pieces, each set of game pieces including three subsets of game pieces, each subset of game pieces including game pieces having a form corresponding to one of the playing location receiving shapes, including a solid cylinder having a first diameter, a hollow cylinder having a second diameter larger than the first diameter, and a hollow cylinder having a third diameter larger than the second diameter.

An object of the game is to add complexity to traditional connection games. Famous connection games such as Tic-Tac-Toe and Connect Four were solved mathematically long ago. While a casual player may not be able to readily identify the correct, solved solution for every game, the fact that the games are solved provides evidence of a fact most people know already: the games can be boring and repetitive over time. This repetitive nature and lack of replay value stems from the lack of complexity and can be attributed to a few factors inherent in these traditional games. The biggest factors in the lack of complexity are the limit of two players per game and the inability to use a playing position more than once per game. The present invention allows at least four players to play simultaneously and all of them to potentially utilize every playing position on a game board. These extra players and playing positions provide exponentially more complexity and possible outcomes for a connection game helping to break up the monotony of these ancient games.

Another goal is to provide a game which is easily scalable in size and complexity. Traditional connection games are almost always larger or smaller versions of the traditional Tic-Tac-Toe grid format. Connect Four is one famous improvement on Tic-Tac-Toe which simply involves a larger playing grid and more playing pieces in-a-row to achieve victory. The present invention not only provides this traditional scalability (e.g., bigger grid of playing positions and more pieces in-a-row to win) but scalability at each playing position. The addition or subtraction of playing locations (e.g., grooves which can accommodate corresponding concentric game pieces) allows for a connection game to be scalded up or down in size without the addition or subtraction of playing positions and the corresponding need for a proportionally larger or smaller playing area and game board.

An advantage of the current invention is that the use of concentric game pieces facilitates multiple players being able to play game pieces in varied playing locations within a single playing position. Traditional Tic-Tac-Toe and Connect Four are both incapable of accommodating more than one game piece or marker at a given playing position. This inability to accommodate multiple players per playing location limits the outcomes of the traditional games and the number of players who can play at one time. The current invention may utilize any number of concentric game pieces per player and feature a corresponding number of playing locations per playing position on the playing area. For example, when a player plays a game piece at a given location within a given position, players may no longer play a same sized piece at that location, but they are free to play any other sized game piece at the location. This functionality allows for a multitude of additional players, play styles, and outcomes for a connection game.

Another advantage of the use of concentric game pieces and corresponding playing locations in a connection game is that the traditional familiarity of connection games is preserved while also boosting the difficulty to master such a game. The biggest draw of games like Tic-Tac-Toe and Connect Four may be their “pick-up and play” nature. The present invention preserves this easy to learn, casual characteristic, but increases the difficulty to master winning strategies. This heightened difficulty in mastering strategies allows new players to enjoy the game while posing an actual challenge during their first time playing and onwards. This added challenge helps to increase replay value and prevent one player from dominating the game.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a perspective view of one embodiment of a scalable connection game.

FIG. 2 is a diagram of a scalable connection game before a gameplay has begun.

FIG. 3A is a diagram of the scalable connection game after one round of play.

FIG. 3B is a diagram of the scalable connection game after two rounds of play.

FIG. 3C is a diagram of a scalable connection game after four rounds of play.

FIG. 4A is a diagram of an ascending order winning combination.

FIG. 4B is a diagram of a concentric winning combination.

FIG. 5A is a perspective view of a scalable connection game featuring multiple playing areas.

FIG. 5B is a perspective view of a scalable connection game featuring stackable game pieces.

FIG. 6 is a diagram of an example of a larger scalable connection game.

FIG. 7 is a diagram of a larger scalable connection game.

### DETAILED DESCRIPTION OF THE INVENTION

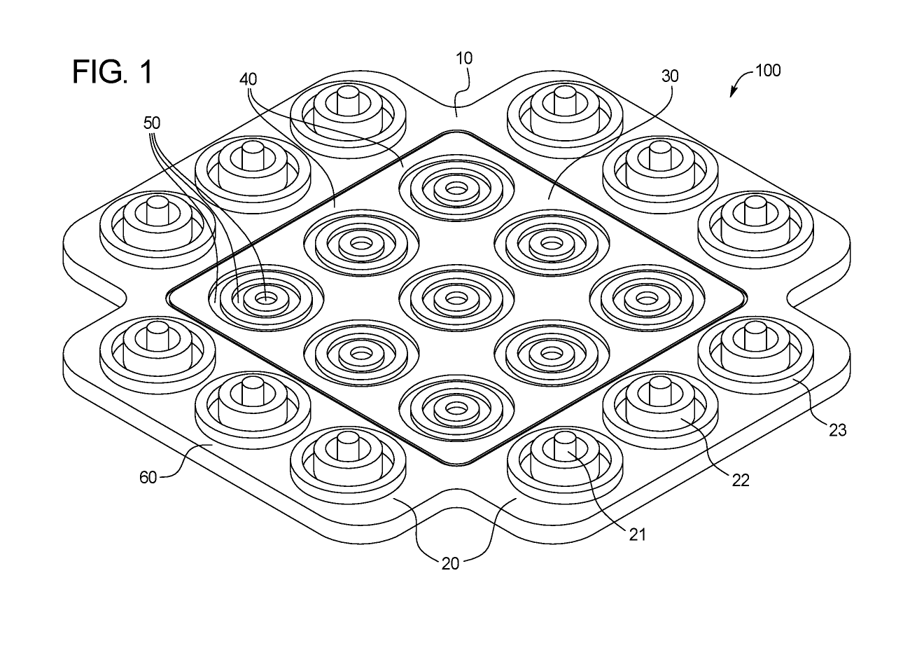

FIG. 1 is a perspective view of one embodiment of a scalable connection game 100. While many variations of the scalable connection game 100 are contemplated (e.g., variations in sizes, shapes, the number of players and playing pieces, two-dimensional vs. multi-dimensional playing surfaces, physical vs. electronic embodiments, etc.), the example shown in FIG. 1 serves as a basic example to which reference may be made to explain the various inventions taught herein.

As shown in FIG. 1, the scalable connection game 100 may include a game board 10 and game pieces 20. The game board 10 may be approximately fourteen inches wide by fourteen inches long with a height of three eights of an inch. The top face of the game board 10 may feature a playing area 30 with the dimensions of approximately eight inches wide by eight inches long. The playing area 30 may consist of a three by three grid of playing positions 40 located in the center of the board 10. Each playing position 40 may be a series of concentric grooves cut approximately one-eighth of an inch deep into the top of the game board 10. These concentric grooves act as multiple playing locations 50 within each playing position 40. Further shown in FIG. 1, the game pieces 20 may be sets of three, concentric, cylindrical game pieces 20, the sets being distinguished by being different colors. In this embodiment of the connection game 100, the pieces 20 may come in small 21, medium 22, and large 23 sizes. The small game piece 21 may be a solid cylinder with the approximate diameter of five-sixteenths of an inch and a height of nine-sixteenths of an inch. The medium game piece 22 may be a hollow cylinder with the approximate diameter of one and one-fourth of an inch and a height of seven-sixteenths of an inch. The large game piece 23 may also be a hollow cylinder with an approximate diameter of two and one-fourth inches and a height of one-half inch. These pieces 20 may be placed in corresponding game piece holders 60 cut to the same dimensions as the playing positions 40. The game piece holders 60 may be placed along the perimeter of the board 10 outside the playing area 30 to hold each of a respective player's game pieces 20 when not in use.

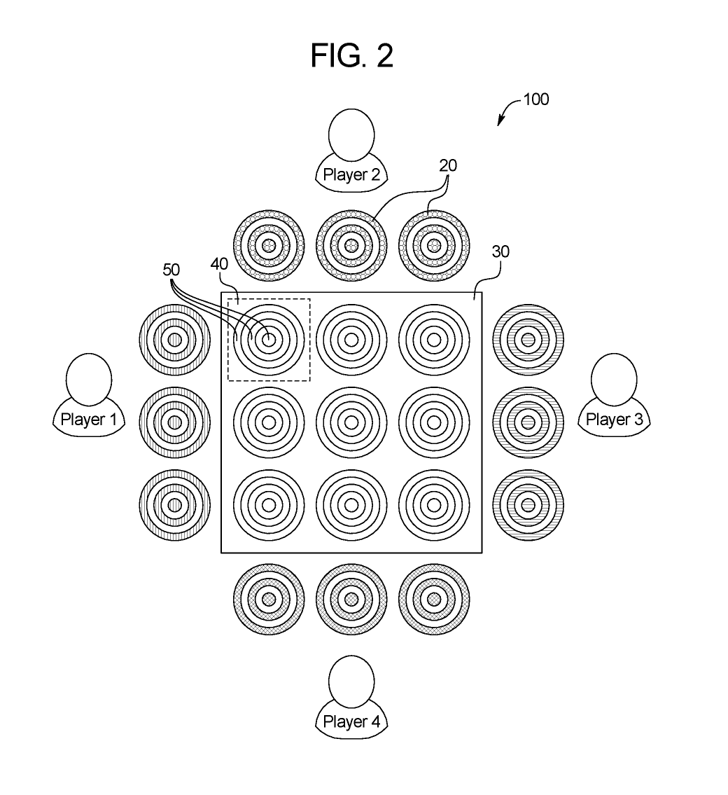

FIG. 2 is a diagram of a scalable connection game 100 before a gameplay has begun. As shown in FIG. 2, the scalable connection game may begin with all the game pieces 20 sitting outside the playing area 30. When a game 100 begins, a player may place one of the game pieces 20 in any of the unoccupied, correspondingly sized playing locations 50 at any of the playing positions 40. Each individual player's game pieces 20 may be of a specific unique color to distinguish them from other players' pieces. Placement of a game piece 20 in a playing location 50 completes each player's turn, with up to three other players taking consecutive turns before the respective player is allowed another turn. Once a game piece 20 is placed at a playing location 50 it may not be moved for the duration of the game.

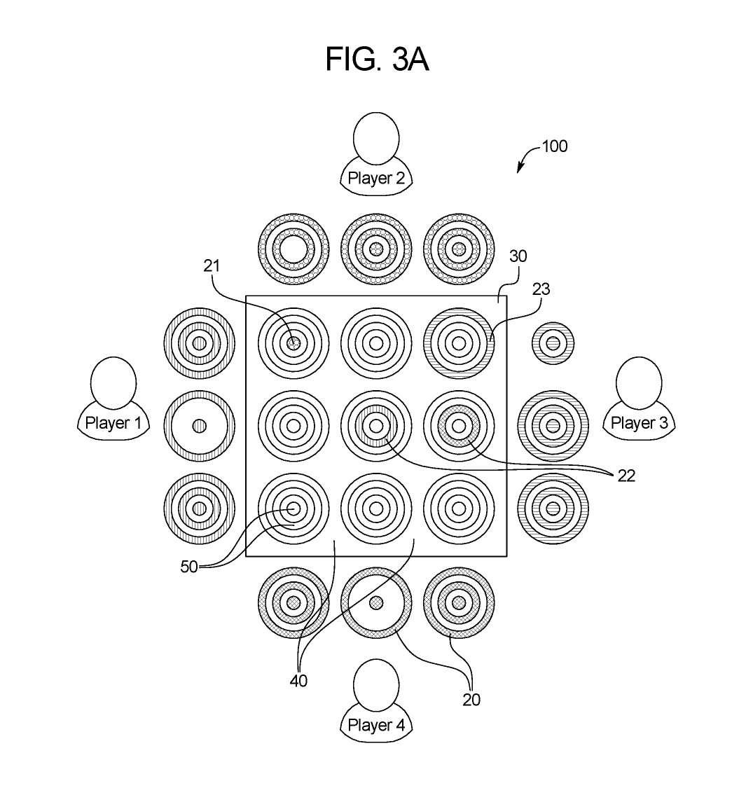

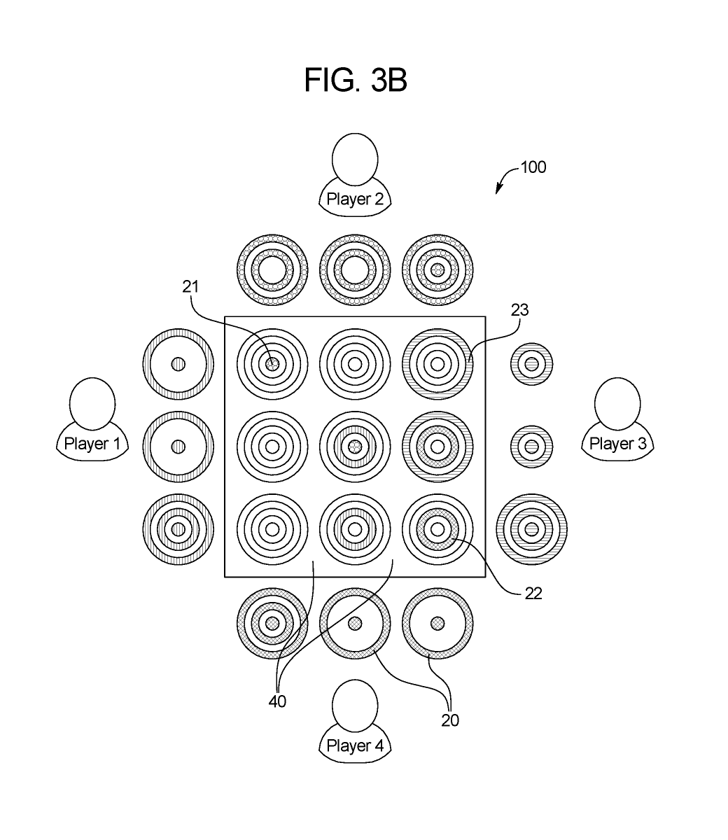

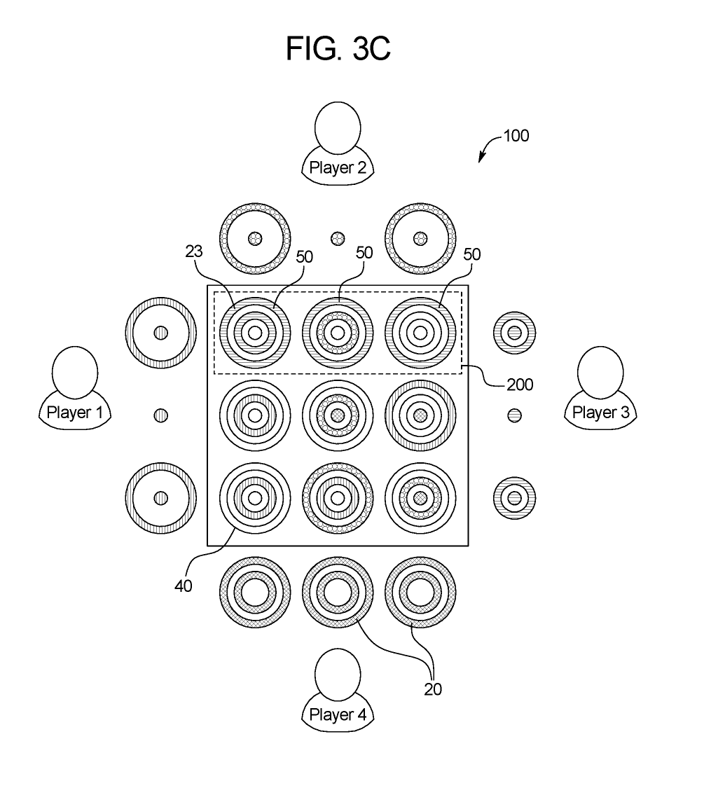

FIG. 3A is a diagram of the scalable connection game 100 after one round of play. As shown in FIG. 3A, each player may play one game piece 20 per turn. The players may play their game pieces 20 at any open playing location 50. In this illustration, player one has played a medium sized game piece 22 in the correspondingly sized playing location 50 of the playing position 40 in the middle of the playing area 30. Player two has played a small game piece 21 at the top left playing position 40 while player three has played a large game piece 23 at the top right playing position 40. Player four has played a medium sized game piece 22 at the middle right playing position 40, which means the first round has ended and the next turn belongs to player one at the start of round two.

FIG. 3B is a diagram of the scalable connection game 100 after two rounds of play. As shown in FIG. 3B, players may again place their game pieces 20 at any unoccupied playing location 50. Player one has opted to place a second medium game piece 22 at the bottom center playing position 40. Player two has placed a second small game piece 21 at the center playing position 40 while player three has played a large game piece 23 at the right center playing position 40. Player four has played a medium sized ring 22 at the bottom right playing position 40, concluding the second round.

FIG. 3C is a diagram of a scalable connection game 100 after four rounds of play. As shown in FIG. 3C, players continue to place game pieces 20 in open playing locations 50 during each round of play until a winning combination 200 is achieved. In this example, a winning combination 200 was achieved in the fourth round by player three. The winning combination demonstrated by FIG. 3C was achieved by placing three of the same sized game pieces 20 in a horizontal, diagonal, or vertical row. In the present example, player three has placed three large game pieces 23 in a horizontal row across the top three playing positions 40.

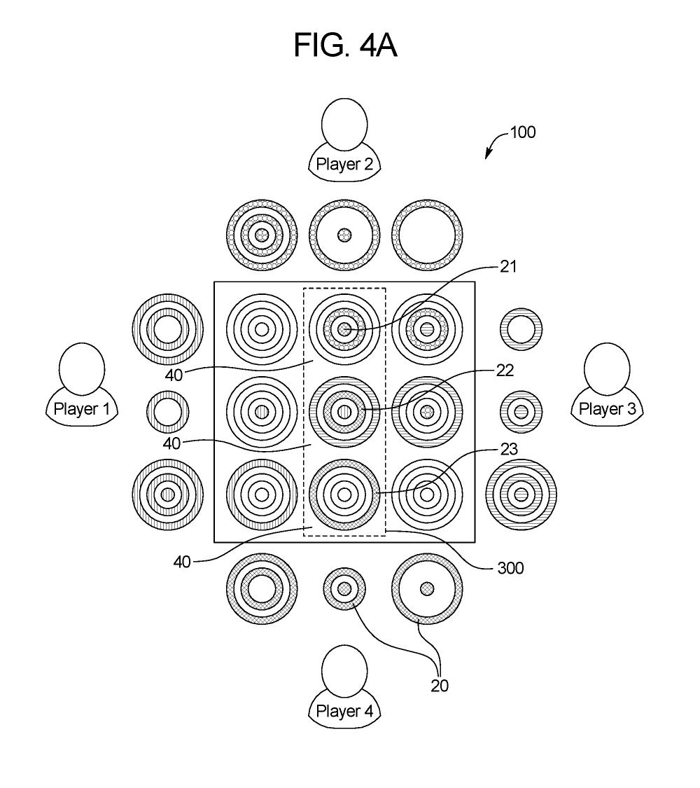

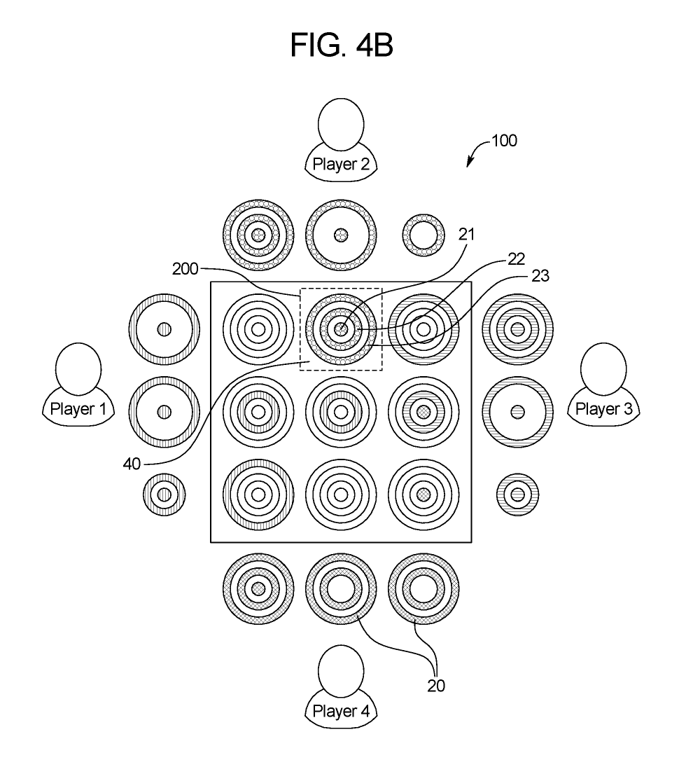

FIG. 4A is a diagram of an ascending order winning combination 200. The winning combination 200 demonstrated in FIG. 4A consists three game pieces 20 in a horizontal, diagonal, or vertical row, but the size of the game pieces in the row are in ascending (or descending) order. This winning combination 200 was achieved by player four, who placed a small game piece 21, medium game piece 22, and large game piece 23 in a row along the top center, center, and bottom center playing positions 40 respectively.

FIG. 4B is a diagram of a concentric winning combination 200. As shown in FIG. 4B, a winning combination may be achieved by placing all sizes of game piece 20 on one playing location 40. Player two has accomplished this winning combination 200 by placing a small game piece 21, medium game piece 22, and large game piece 23 all on the top center playing position 40.

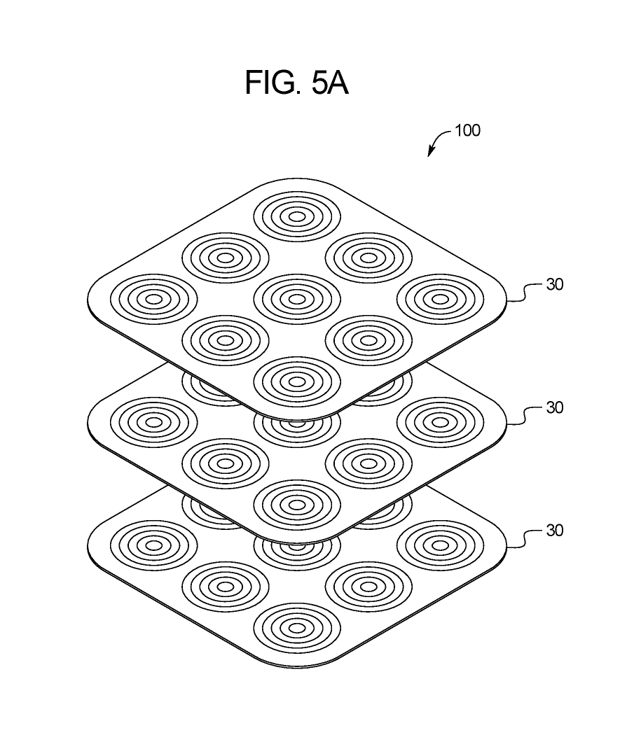

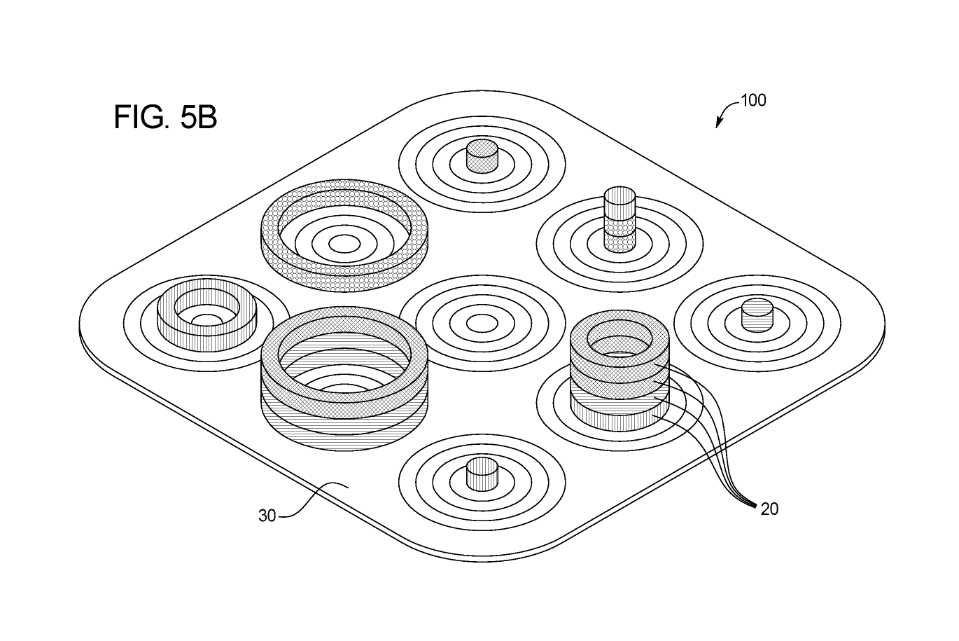

FIG. 5A is a perspective view of a scalable connection game 100 featuring multiple playing areas 30. As shown in FIG. 5A, to add additional complexity to the scalable connection game 100 described with reference to FIGS. 1-4B, multiple playing areas 30 may be placed above and/or below each other (or placed in other configurations understood to represent a three-dimensional playing space). In this configuration, the previously disclosed two-dimensional versions of winning combinations 200 may be employed to achieve victory as well as three-dimensional versions of the winning combinations 200.

FIG. 5B is a perspective view of a scalable connection game 100 featuring stackable game pieces 20. As shown in FIG. 5B, to add additional complexity to the scalable connection game 100 discussed previously, the game pieces 20 may be stacked upon one another. This stacking allows for the addition of three-dimensional gameplay, including three dimensional versions of the winning combinations 200 discussed in FIG. 5A, to occur on a single playing area 30.

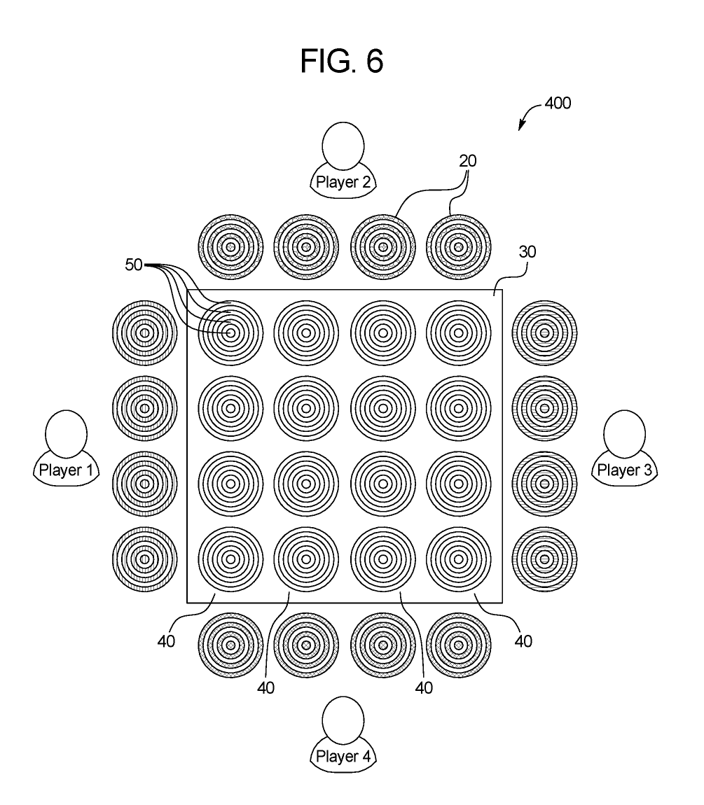

FIG. 6 is a diagram of an example of a larger scalable connection game 400. As shown in FIG. 6, the scalable connection game described with reference to FIGS. 1-4B may be expanded to create a larger scalable connection game 400. This expansion may be seen in several features of the game 400. The larger game 400 may feature a playing area 30 that features a four by four grid of playing positions 40. The larger game 400 may also feature an increased number of playing pieces 20 given to each player with this embodiment featuring four sets of four concentric game pieces 20 given to each player. This expanded number of game piece 20 sizes means there is also a corresponding increase in the number of playing locations 50 at each playing position 40. With the increase in size of the playing area 30, playing positions 40, playing locations 50, and game pieces 20 there may also be a corresponding increase in the number of game pieces 20 required to obtain a winning combination 200. In the embodiment pictured in FIG. 6, the formations for winning combinations 200 disclosed in FIGS. 3C-4B may still be employed, but each of them require an additional game piece 20 (e.g., four-in-a-row) to achieve victory.

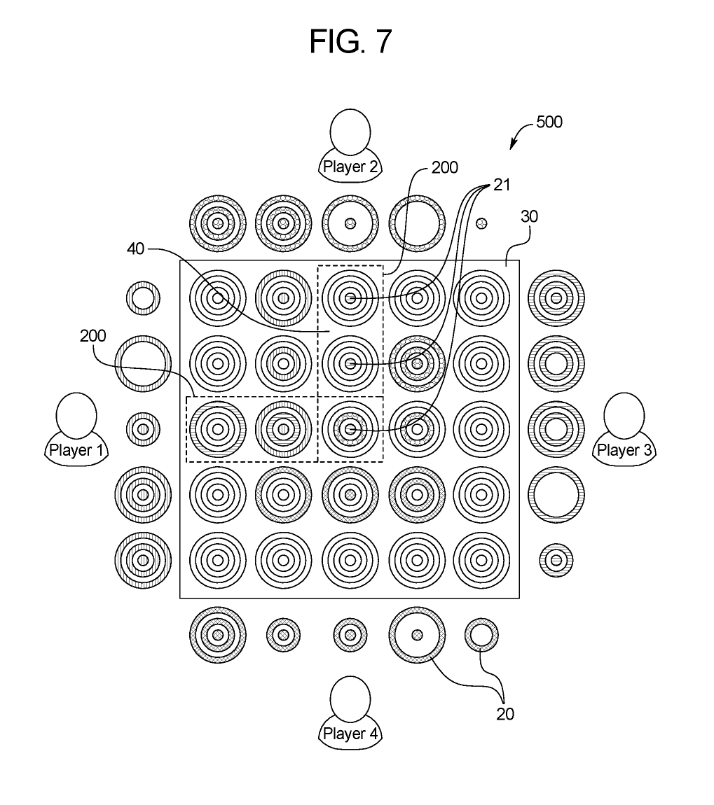

FIG. 7 is a diagram of a larger scalable connection game 500. As shown in FIG. 7, the scalable connection game described with reference to FIGS. 1-4B may be expanded to create a larger scalable connection game 500. In contrast to the expansion seen in FIG. 6, the larger scalable connection game 500 may only increase the number of playing positions 40 (and thus size of playing area 30) and number of sets game pieces 20 given to the players. In this larger game 500, the number of playing positions 40 in increased to a five by five grid. The resulting larger playing area 30 is accounted for by the players receiving five sets of three concentric game pieces 20. This larger scalable connection game 500 may employ the same winning combinations 200 discussed in FIGS. 3C-4B but, to provide extra complexity, two such wining combinations 200 may be required to be achieved by a player to obtain victory. Such a scenario is shown in FIG. 7, wherein player three has obtained both a three-in-a-row winning combination 200 of small game pieces 21 and an ascending ordering winning combination 200.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A game comprising:
a playing area including an arrangement of playing positions, each playing position including two or more playing locations within the playing position, each playing location having an associated receiving shape; and
two or more sets of game pieces, each set of game pieces including two or more subsets of game pieces, each subset of game pieces including two or more game pieces having a form corresponding to one of the playing location receiving shapes.

2. The game of claim 1 wherein the playing locations within each playing position are concentric.

3. The game of claim 1 wherein the playing area is a three by three grid of playing positions.

4. The game of claim 1 wherein the playing area is a four by four grid of playing positions.

5. The game of claim 1 wherein the playing area is a five by five grid of playing positions.

6. The game of claim 1 wherein the playing area is provided on a board.

7. The game of claim 1 wherein the playing area is provided on a display of an electronic device.

8. The game of claim 1 wherein there are four sets of game pieces and each set of game pieces include three subsets of game pieces.

9. The game of claim 8 wherein the three subsets of game pieces include game pieces in three concentric shapes.

10. The game of claim 9 wherein the three concentric shapes include a solid cylinder having a first diameter, a hollow cylinder having a second diameter larger than the first diameter, and a hollow cylinder having a third diameter larger than the second diameter.

11. The game of claim 1 further including game piece holding locations that are the same form of the playing locations and are located along the perimeter of the playing area.

12. The game of claim 1 wherein the playing area is three-dimensional.

13. A game comprising:
a playing area including a grid arrangement of nine playing positions, each playing position including three concentric playing locations within the playing position, each playing location having an associated cylindrical receiving shape; and
four sets of game pieces, each set of game pieces including three subsets of game pieces, each subset of game pieces including game pieces having a form corresponding to one of the playing location receiving shapes, including a solid cylinder having a first diameter, a hollow cylinder having a second diameter larger than the first diameter, and a hollow cylinder having a third diameter larger than the second diameter.

14. The game of claim 13 wherein the the playing area is provided on a board.

15. The game of claim 13 wherein the playing area is provided on a display of an electronic device.
